(19) United States
(12) Patent Application Publication
(10) Pub. No.: US 2013/0242559 A1
(43) Pub. Date: Sep. 19, 2013

(54) Light Emitting Diode Lamp

(71) Applicant: PSI TECHNOLOGIES, INC., Calamba (PH)

(72) Inventors: Thomas Joachim Werner MOERSHEIM, Calamba (PH); Fernando Villon Capinig, Calamba (PH); Anthony Augusto Malon Galay, Calamba (PH)

(21) Appl. No.: 13/831,270

(22) Filed: Mar. 14, 2013

Related U.S. Application Data
(60) Provisional application No. 61/611,014, filed on Mar. 15, 2012.

(51) Int. Cl. F21V 29/00

(52) U.S. Cl. CPC F21V 29/22
USPC 362/249.02

(57) ABSTRACT

The present invention provides a light-emitting diode (LED) lamp (100, 100a, 100b, 100c). The LED lamp (100, 100a, etc.) comprises a plug (110, 110a, 110b) having two contacts for electrical connections to two respective electric power supply conductors, a fixture (120, 120a, 120b, 120c, 120d) connected to the plug and a plurality of LEDs (11) mounted onto the fixture (120, 120a, etc.), so that heat is conducted directly away from the LEDs (11) through the fixture and plug. When the LED lamp is connected to a lamp holder (20) and electric power is supplied from the power supply conductors, heat generated from operation of the LEDs (11) is conducted away through the fixture, plug and power supply conductors to the ambience.

### RELATED APPLICATIONS

This application claims priority to U.S. provisional application Ser. No. 61/611,014 filed on Mar. 15, 2012, the disclosure of which is herein incorporated in its entirety.

### FIELD OF THE INVENTION

The present invention relates to light emitting diode (LED) lamps. In particular, the present invention relates to LED lamps in which waste heat is dissipated away along a thermal conduction path from the LED junction, to the lamp holder and then to the electric power conductors.

### BACKGROUND

A light-emitting diode (LED) lamp uses solid-state light-emitting diodes as sources of illumination. For example, a LED light bulb is made to replace screw-in incandescent or compact fluorescent light bulbs, since LED light bulb is more power-efficient and has a longer life compared to the conventional light bulbs or light tubes.

A LED lamp is typically assembled with a plurality of LEDs. The operation of a plurality of LEDs raises the temperature of the LEDs rapidly. The waste heat needs to be removed from the LEDs, as the temperature of the light-emitting junctions is higher, the faster the LEDs fail. Often, the life of a conventional LED lamp is less than the 50,000 hours a LED is expected to last.

Various methods to dissipate waste heat of the LED light bulb are widely known in the art. Most common method used is by thermally conducting the waste heat generated to a special heat sink. Typically, the heat sink is being integrated into the LED lamp. The waste heat from the heat sink is accordingly dissipated to the atmosphere.

Another method known for dissipating waste heat of LED lamp is by having the holder of the LED lamp filled with a heat transfer fluid. The heat transfer fluid conducts and convects the waste heat from the LEDs to the holder, and eventually transfers it to the atmosphere.

Whether using a heat sink or heat transfer liquid to dissipate the waste heat, the transfer of the waste heat of the LED lamp to the atmosphere in a well-ventilated atmosphere is sufficiently effective for a low wattage LED lamp. However, problems arise when the LED lamp is operated in a poorly-ventilated atmosphere, such as, in an enclosed lighting fixture or concealed ceiling fitting. The waste heat transfer process in a poorly-ventilated atmosphere is undoubtedly inadequate, so the LED lamp cannot dissipate the waste heat effectively. Consequently, the lifespan of the LED lamp is significantly reduced. With the pull/push for higher energy efficiency, the reduced life of LED lamp for illumination using higher wattage LED lamps remains an issue.

FIG. 1 shows a typical prior art LED lamp 10. The LED lamp 10 comprises at least one light-emitting diodes 11, a base 12 for electrical and mechanical connection to a lamp holder 20, an electronic driver assembly (not shown) disposed in the base 12 for converting electric energy into a power suitable for the light-emitting diodes 11, a mechanical and electrical assembly (not shown) disposed in the base 12 to hold and connect the light-emitting diodes 11 to the electronic driver assembly, a transparent enclosure 14 to protect the internal components of the LED lamp 10 and to enable light to emit into the environment, a housing 15 to connect the transparent enclosure 14 to the base 12 and, at the same time, to act as a heat-sink for waste heat transfer to the environment.

Despite development of LED lamps, there is still a need to lower the junction temperature at the LED to achieve the 50,000 hours life expected of a LED. With improved heat dissipation, it is then possible to provide LED lamps with higher lumen for illumination.

### SUMMARY

In one aspect of the present invention, there is provided a light emitting diode (LED) lamp. The LED lamp comprises a plug having two contacts for electric connections to two respective electric power supply conductors; a fixture for mounting onto the plug; and a plurality of LEDs for mounting on the fixture, wherein the fixture conducts heat away from the plurality of LEDs to the plug. When the LED lamp is connected to a lamp holder and power is supplied from the electric power supply conductors, heat generated from operation of the plurality of LEDs is conducted away through the fixture, plug and electric power supply conductors to the ambience

Preferably, the fixture comprises a heat conductive material, which includes a metal, such as copper or aluminium.

Preferably, the fixture comprises an elongate member, which is thermal conductively and electrically connected directly to either of the electric power supply conductor. The associated plug is configured at an end of a long fluorescent tube with two terminal pins, and the elongate member is connected to either of the terminal pin.

Preferably, the fixture comprises two elongate members, which are thermal conductively and electrically connected directly to either of the electric supply conductors. In another embodiment, each elongate member is thermal conductively and electrically connected directly to separate power supply conductors.

When the plug is configured with a screw thread, bayonet or PL connection, a distal end (opposite the mounting end at the plug) of the elongate member is formed with one or more flat segments that is/are inclined at a predetermined angle, such that a LED is mountable on a flat segment. Preferably, the plug comprises a peripheral surface and a base tip, such that the peripheral surface is metallic and is connected to an AC neutral line of the electric power supply conductors, whilst the base tip is connected to an AC live line of the electric power supply conductors.

When the plug is configured at an end of a long fluorescent tube with two terminal pins, each of the elongate members of the fixture is connected separately to the terminal pins. Preferably, each plug is associated with an electronic driver assembly that supplies DC power to the LEDs.

### BRIEF DESCRIPTION OF THE DRAWINGS

This invention will be described by way of non-limiting embodiments of the present invention, with reference to the accompanying drawings, in which:

FIG. 1 illustrates a typical prior art LED light bulb integrated with a heat sink;

FIG. 2A illustrates a LED lamp according to one embodiment of the present invention; FIG. 2B illustrates an exploded view of the LED lamp shown in FIG. 2A together with a matching lamp holder; whilst FIG. 2C illustrates a LED lamp with a parabolic reflector;

FIGS. 3A-3C illustrate schematics of internal fixtures of LED lamps according to other embodiments of the present invention; and

FIGS. 4A and 4B illustrate schematics of a LED lamp according to yet other embodiments of the present invention.

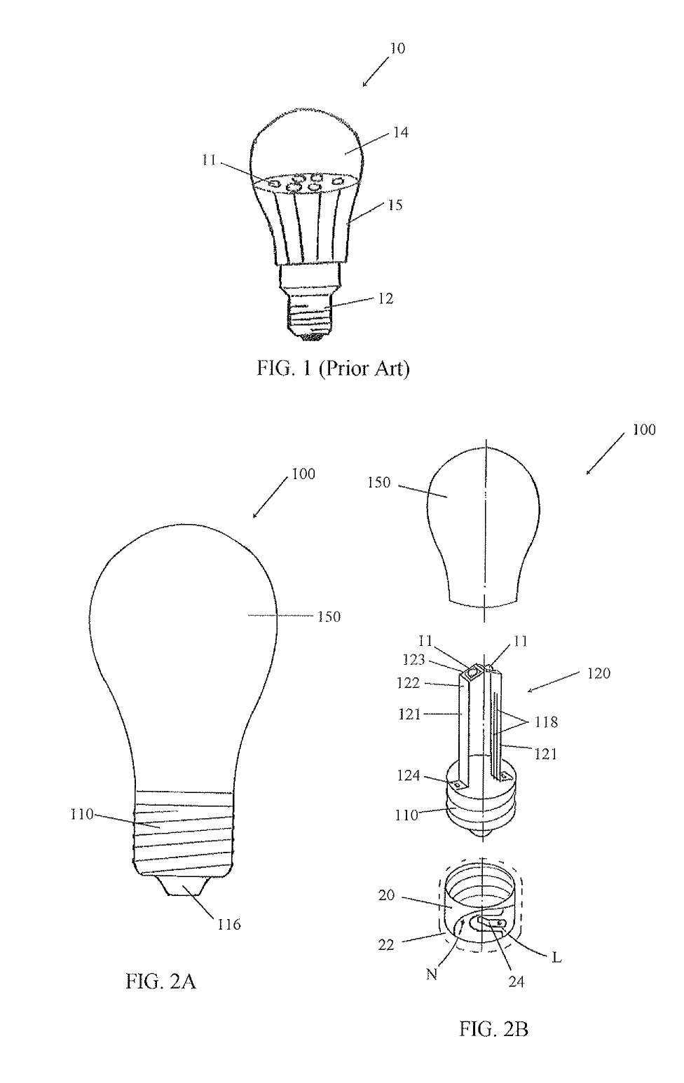

### DETAILED DESCRIPTION

One or more specific and alternative embodiments of the present invention will now be described for a reader to understand the inventive features of the present invention. It shall be apparent to one skilled in the art, however, that this invention may be practiced without such specific details. Some of the details may not be described in length so as to not obscure the invention. For ease of reference, common reference numerals will be used throughout the figures when referring to same or similar features common to the figures.

As outlined above, waste heat dissipation of LEDs is very crucial as it directly affects the lifespan of the LED lamp. For example, an increase of a few degree C. in the LED junction reduces the lifespan of a LED by several months, and a 20 degree C. increase will take years out of the lifespan. The present invention provides a LED lamp 100 with good heat dissipation capability, thus ensuring the designed lifespan of the LED lamp is not adversely reduced. Advantageously, the LED lamp of the present invention dissipates its waste heat along a continuous thermal conduction path from a fixture and lamp holder to the electric power supply conductors rather than to a heat sink.

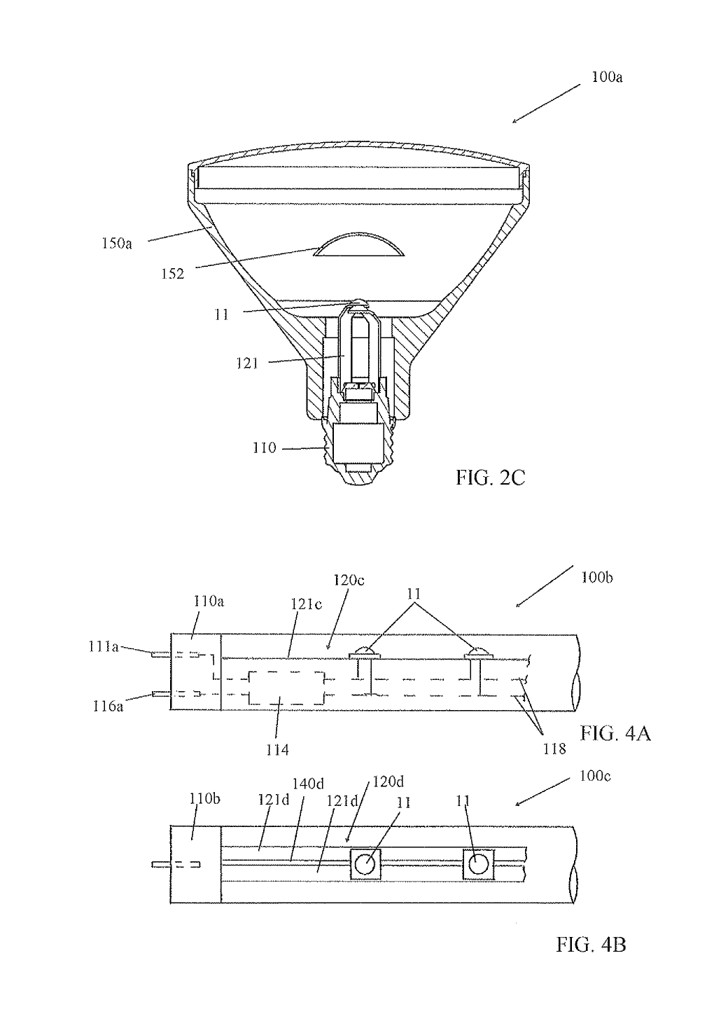

FIG. 2A shows an external view of a LED lamp 100 according to an embodiment of the present invention, whilst FIG. 2B shows an exploded view of the LED lamp 100. Referring to FIGS. 2A and 2B, the LED lamp 100 comprises a plurality of LEDs 11 mounted at a free end of a fixture 120, with an opposite end of the fixture being joined to a plug 110. A lamp cover 150, for connection with the plug 110, is provided to fit over the fixture 120. In use, the lamp cover 150 protects the fixture 120 and LEDs 11, but allows light to radiate from the LEDs 11 to illuminate the ambience.

Still referring to FIG. 2A, the fixture 120 is shown to be made up of two elongate metallic legs 121 with the distal ends 122 being joined together and the proximal ends 124 are bent for mounting onto the plug 110. The surface 123 at the distal end 122 is formed at an angle to the legs 121 thereby providing one or more flat segments. Each flat segment on the surface 123 is sized and dimension for mounting a LED 11 assembly. For illustration purposes, the surface 123 is shown with a flat sloping segment in FIG. 2B. It is possible that the surface 123 is shaped like a pyramid with a polygonal base. Preferably, the segmented surfaces 123 are configured at various angles so that light from the plurality of LEDs 11 is projected out through the lamp cover 150 for optimal illumination. In one embodiment, the metallic legs 121 have a length L of about 34 mm, a width W of about 6 mm and a thickness T of about 1 mm. In another embodiment, the proximal ends 124 of the fixture 120 are mounted onto the plug 110 with screws; in another embodiment, the proximal ends 124 of the fixture 120 are mounted onto the plug with rivets. It is possible that the fixture 120 be mounted onto the plug 110 by other connection means, as long as the connection is reliable and it provides a continuous thermal conduction path to dissipate heat away from the fixture 120 to the plug 110. As a reader will appreciate later, in use, this continuous thermal conduction path extends to the electric supply conductors from the lamp holder 20. It is even possible to embed the proximal ends 124 in the plug 110 to form an integral sub-assembly.

In FIG. 2B, the lamp holder 20 is shown with the AC neutral line N being connected to a screw socket for receiving the screw plug 110. The AC live line L is connected to a spring terminal 24, which in use is electrically connected to a base tip 116 on a bottom side of the screw plug 110. For illustration purposes, the insulator 22 around the lamp holder is not shown.

In one embodiment of the present invention, the fixture 120 is made of metal or any other good thermal conductor materials. Preferably, the fixture 120 is made of copper or aluminium, as copper and aluminium are good thermal conductors.

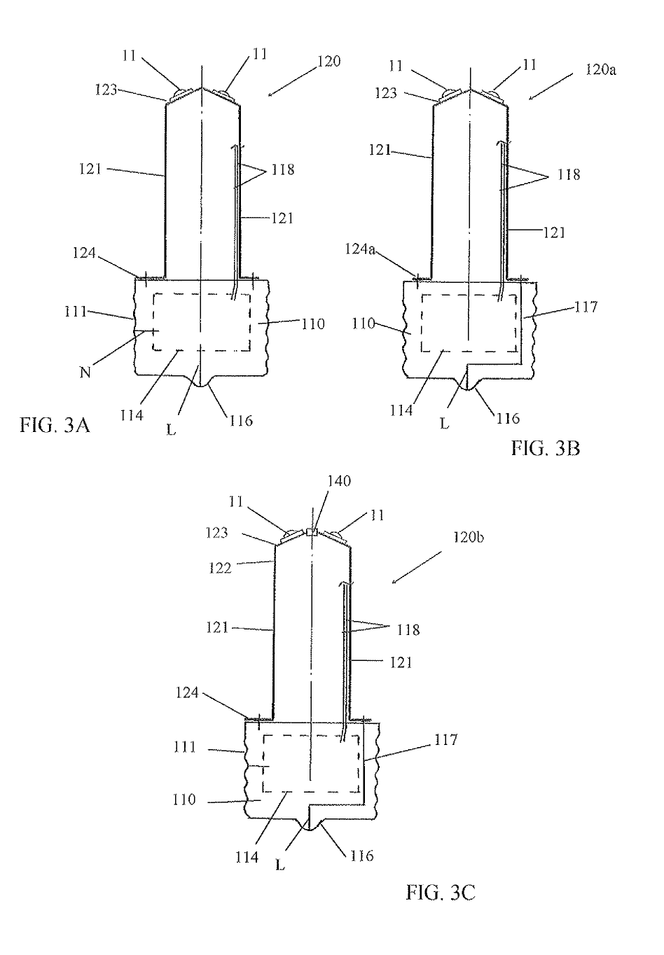

When the LED lamp 100 is configured for screw connection, as shown in FIGS. 2B and 3A, a peripheral surface 111 of the plug 110 is metallic and is formed with a screw thread. In one embodiment, a proximal end 124 of the fixture 120 is in contact with the peripheral, metallic surface of the plug 110 so that the fixture 120 is in continuous thermal conduction with the metallic plug 110. In use, when the LEDs 11 are powered up, heat generated at the LEDs 11 is conducted immediately away from the LEDs through the fixture 120 and the metallic surface 111 of the plug 110. The heat energy is conducted to the lamp holder 20 through the plug 110 and is then dissipated away along the electric supply conductor N terminated at the lamp holder 20. In this way, heat generated at the LEDs 11 is conducted away so that the designed life of the LEDs 11 is not adversely affected. In effect, the operating life of the LED lamp 100 according to the present invention is substantially at or exceeds the designed life; in other words, with the present invention, the long life of LED is not compromised. Also with this invention, long life of LEI) lamp with higher lumen or power, such as 100 W or more, is now made possible and there is an economic advantage for promoting more prevalent use of LED lamps.

As shown in FIG. 3A, an electronic driver assembly 114 is disposed inside the plug 110 with the AC neutral line N being connected to the peripheral, metallic screw surface 111 of the plug and the AC live line L being connected to a base tip 116 of the plug 110. Also as shown, the DC output lines 118 from the electronic driver assembly 114 supply electric power to the plurality of LEDs 11. The electronic driver assembly 114 controls and regulates power to the LEDs 11. The DC output lines 118 of the electronic driver assembly 114 are electrically isolated from the fixture 120.

FIG. 3B shows a fixture 120a according to another embodiment. The fixture 120a is similar to the above embodiment 120 except that the fixture 120a is thermally and electrically connected to the AC live line L via the base tip 116, but the fixture 120a is electrically isolated from the peripheral, screw surface 111 of the plug 110. In use, heat generated at the LEDs is conducted away directly through the fixture 120a and the electric supply conductor L, and indirectly through the plug 110, the lamp holder 20 and the electric supply conductor N.

FIG. 3C shows a fixture 120b according to another embodiment. The fixture 120b is similar to the above fixtures 120, 120a except that the two elongate legs 121 are electrically isolated from each other at the distal ends 122 by an isolator 140. The isolator 140 mechanically connects the distal ends 122 of the legs 121 together and provides rigidity to the fixture 120b. In this embodiment, a leg 121 of the fixture 120b is connected to the peripheral surface 111 of the plug 110 whilst the other leg 121 is connected to the base tip 116 of the plug. In use, heat generated at the LEDs is conducted away along both the electric supply conductors N, L.

Referring back to FIG. 2C, it shows another LED lamp 100a of the present invention. This lamp embodiment 100a is similar to the above embodiment 100 except that the lamp cover 150a is of another shape and that there is a parabolic aluminium reflector 152 to provide homogeneous light output from the lamp.

FIG. 4A shows a LED lamp 1001) according to another embodiment of the present invention. As shown partially in FIG. 4A, the LED lamp 100b is of the long fluorescent form factor and has a plug 110b at each of the two ends. As shown, each plug 110b has two terminal pins 111a, 116a for separate connection to the AC power supply conductors N, L and the LEDs 11 are thermally connected to a leg 121c of a fixture 120c. In one embodiment, the leg 121c of the fixture 120c is connected to the terminal pin 111a; in another embodiment, the leg 121c of the fixture 120c is connected to the terminal pin 116a. As in the previous embodiments, heat generated at the LEDs 11 is dissipated away through the fixture 120c, terminal pin and either of the electric supply conductor N or L. In one embodiment, the electronic driver assembly 114 is connected to one of the plugs 110b, whilst the plug at the opposite end is provided for only mechanical support with a lamp holder; in another embodiment, two electronic driver assemblies 114 are provided and each driver assembly is connected separately to each of the plugs 110b at the two ends so that each driver assembly 114 supplies power to a number of the LEDs 11, preferably an equal number of LEDs to each driver assembly.

FIG. 4B shows a LED lamp 100c according to yet another embodiment. The LED lamp 100c is similar to the above LED lamp 100b except that fixture 121d is made up of two parallel legs 121d on which the LEDs are straddledly mounted. The two legs 121d are electrically isolated from each other by an isolator 140d but are separately connected to the terminal pins 111a, 116a. In use, both the legs 121d of the fixture 120d conduct heat from the LEDs 11 through the terminal pins separately to both the electric supply conductors N, L.

From the above description, a reader will appreciate that the LED lamps of the present invention rely on heat conduction as the primary mode of heat dissipation from the LED junctions. Heat dissipation from the LED lamp by conduction is found to be more effective than convection or radiation. For example, assuming a LED is heated to a temperature T₂ of 75 degreeC and the ambient temperature T₁ is 25 degreeC, the comparative amounts of heat power dissipation according to the conduction, convection and radiation are:

### Conduction:

$$\begin{matrix}Power = k \cdot ( {A}_{1} \text{/} L ) \cdot ( {T}_{2} - {T}_{1} ) \\ = 380 \cdot ( 0.006 \times 0.001 \text{/} 0.034 ) \times 2 \cdot ( 75 - 25 ) \\ = 6.7 W\end{matrix}$$

where:

k is the heat conductivity in W/mC for copper or aluminium; and

A₁ is the cross-section area in m² (assuming, each leg 121 of the fixture shown in

FIG. 2B or 2C is 6 mm wide, 1 mm thick and about 34 mm long.)

### Convection:

$$\begin{matrix}Power = h \cdot {A}_{2} \cdot ( {T}_{2} - {T}_{1} ) \\ = 100 \cdot ( 0.034 \times ( 0.001 + 0.006 ) \times 2 \times 2 \cdot ( 75 - 25 ) \\ = 4.76 W\end{matrix}$$

where:

h is the convective heat transfer coefficient in W/m²C; and

A₂ is the surface area of the fixture 120.

### Radiation:

$$\begin{matrix}Power = sigma \cdot {A}_{2} \cdot {T}_{2}^{4} \\ = 5.67 \times {10}^{- 8} \cdot ( 0.034 \times ( 0.001 + 0.006 ) \times 2 \times 2 \cdot {( 75 + 273 )}^{4} \\ = 0.79 W\end{matrix}$$

where:

sigma is the Stefan-Boltzmann constant;

A₂ is the surface area of the fixture 120; and

T₂ is in degree Kelvin.

In the above convective heat dissipation calculation, the result is reasonable if there is no lamp cover 150; with the lamp cover, the effective heat dissipation from the LED is much lower. From the above calculations, it is thus reasonable to conclude that heat dissipation by conduction is the most effective mode for reducing LED junction temperature.

The heating effect on the electric supply conductors is now examined. From physical law, as a conductor becomes heated up, its resistance increases proportionally as follow:

Delta R/R₀=alpha·(T₂−T₁)

Assuming, all the heat energy from the LEDs is conducted to the electric supply conductors and the electric supply conductors are heated to temperature T₂ of 75 degreeC, the ambient temperature T₁ remains at 25 degreeC, the resultant resistance is R and the initial resistance is R₀, the above equation simplifies to:

R=R₀·(1−alpha·(T₂−T₁))

If the initial resistance R₀ is 100 ohms and the thermal temperature coefficient, alpha, is 3.9×10⁻³/C for copper or aluminium, then

$$\begin{matrix}R = 100 \cdot ( 1 + 3.9 \times {10}^{- 3} \cdot ( 75 - 25 ) ) \\ = 100 \cdot ( 1 + 0.195 )\end{matrix}$$

From the above calculation, it is seen that a 50 degreeC increase in conductor temperature causes a resistance increase of only about 20%. It is thus reasonable to conclude that an increase in the electric supply conductor temperature results in a small increase in resistance; in contrast, a 50 degreeC increase in the LED junction temperature will adversely reduce the long life of a LED.

From the above description, the LED lamp 100, 100a, 100b, 100c according to the present invention dissipates waste heat effectively through the electric power supply conductors, thereby giving it a lifespan that is longer than a conventional LED lamp. The LED lamp does not require any heat sink, thus the manufacturing cost of the same is accordingly lower; in addition, the lamp of the present invention can be used with existing luminaries and incandescent lamp holders, instead of lamp holders with heat-sinks. The LED lamp of the present invention is also usable in all environmental operation conditions, even in a very poor-ventilated environment or concealed fitting. Whilst the plug is shown with screw bulb form factor, it can be configured in other form factors, such as, the bayonet and PL forms. Other bi-pin form factors are also possible, such as those with two side or end prongs. Consequently, the LED lamp of the present invention with enhanced heat dissipation will allow wider use of higher lumen LED lamps for illumination in the future.

The above description illustrates various embodiments of the present invention along with examples of how aspects of the present invention may be implemented. While specific embodiments have been described and illustrated it is understood that many charges, modifications, variations and combinations thereof could be made to the present invention without departing from the scope of the present invention. For example, the two elongate legs 121d of the fixture shown in FIG. 4B may be polished finished and orientated at an angle to each other to additionally act as reflectors. The above examples, embodiments, instructions semantics, and drawings should not be deemed to be the only embodiments, and are presented to illustrate the flexibility and advantages of the present invention as defined by the following claims:

We claim:

1. A light-emitting diode (LED) lamp comprising:
a plug having two contacts for electric connections to two respective electric power supply conductors;
a fixture for mounting onto said plug; and
a plurality of LEDs for mounting on said fixture;
wherein said fixture conducts heat away from said plurality of LEDs to said plug and, when said LED lamp is connected to a lamp holder and power is supplied from said electric power supply conductors, heat generated from operation of said plurality of LEDs is conducted away through said fixture, plug and electric power supply conductors to the ambience.

2. The LED lamp according to claim 1, wherein said fixture comprises a heat conductive material, which includes a metal, copper or aluminium.

3. The LED lamp according to claim 1, wherein said fixture comprises an elongate member, which is thermal conductively and electrically connected directly to either of said electric power supply conductors.

4. The LED lamp according to claim 1, wherein said fixture comprises two elongate members.

5. The LED lamp according to claim 4, wherein both elongate members are thermal conductively and electrically connected directly to either of said electric power supply conductors.

6. The LED lamp according to claim 4, wherein each member is thermal conductively and electrically connected directly to separate said power supply conductors.

7. The LED lamp according to claim 6, further comprising an electrical insulator separating said two elongate members of said fixture.

8. The LED lamp according to claim 4, wherein, when said plug is configured with a screw thread, bayonet or PL connection, a distal end (opposite the mounting end at said plug) of said elongate member is formed with one or more flat segments that is/are inclined at a predetermined angle, such that a LED is mountable on a said flat segment.

9. The LED lamp according to claim 8, wherein said plug comprises a peripheral surface and a base tip, such that said peripheral surface is metallic and is connected to an AC neutral line of said electric power supply conductors, whilst said base tip is connected to an AC live line of said electric power supply conductors.

10. The LED lamp according to claim 3, wherein, when said plug is configured at an end of a long fluorescent tube with two terminal pins, said elongate member of said fixture is connected to either of said terminal pins.

11. The LED lamp according to claim 4, wherein, when said plug is configured at an end of a long fluorescent tube with two terminal pins, each of said elongate members of said fixture is connected separately to said terminal pins.

12. The LED lamp according to claim 4, wherein said plug comprises two plugs, and each said plug is configured at each of two ends of a long fluorescent tube.

13. The LED lamp according to claim 12, wherein each said plug is associated with an electronic driver assembly that supplies DC power to a predetermined number of said plurality of LEDs.

14. The LED lamp according to claim 13, wherein said predetermined numbers of LEDs associated with each said plug is equally divided.
